(19) United States
(12) Patent Application Publication
(10) Pub. No.: US 2024/0386125 A1
(43) Pub. Date: Nov. 21, 2024

(54) SYSTEM AND METHOD FOR IMPLEMENTING DIFFERENTIALLY PRIVATE PRINCIPAL COMPONENT ANALYSIS (PCA) FOR VERTICALLY PARTITIONED DATA

(71) Applicant: Garena Online Private Limited, Singapore (SG)

(72) Inventors: Ergute BAO, Singapore (SG); Tianyu PANG, Singapore (SG); Chao DU, Singapore (SG)

(21) Appl. No.: 18/665,123

(22) Filed: May 15, 2024

(30) Foreign Application Priority Data
May 16, 2023 (SG) 10202301371Q
May 14, 2024 (SG) 10202401326R

(51) Int. Cl. G06F 21/62; G06F 21/60

(52) U.S. Cl. CPC G06F 21/6218; G06F 21/604

(57) ABSTRACT

Provided herein are systems, methods, and computer-readable media for implementing differentially private principal component analysis (PCA) for vertically partitioned data. An example system can include a first client possessing a first column vector, and a second client possessing a second column vector. The first client can be configured to discretize the first column vector to obtain a first discretized column vector and the second client can be configured to discretize the second column vector to obtain a second discretized column vector. The first client can be configured to introduce a first noise to the first discretized column vector and the second client can be configured to introduce a second noise to the second discretized column vector to obtain a PCA result.

### CROSS-REFERENCE TO RELATED APPLICATIONS

This patent application claims the benefit of and priority to Singaporean Non-Provisional patent application Ser. No. 10/202,401326R, filed with the Intellectual Property Office of Singapore on 14 May 2024, entitled “SYSTEM AND METHOD FOR IMPLEMENTING DIFFERENTIALLY PRIVATE PRINCIPAL COMPONENT ANALYSIS (PCA) FOR VERTICALLY PARTITIONED DATA”, which claims priority to Singaporean Provisional Patent Application No. 10/202,301371Q, filed with the Intellectual Property Office of Singapore on 16 May 2023, entitled “SYSTEM AND METHOD FOR IMPLEMENTING DIFFERENTIALLY PRIVATE PRINCIPAL COMPONENT ANALYSIS (PCA) FOR VERTICALLY PARTITIONED DATA”, the contents of which are incorporated by reference in their entirety and for all purposes.

### TECHNICAL FIELD

Various aspects of this disclosure relate to systems and methods for implementing differentially private principal component analysis (PCA) for vertically partitioned data.

### BACKGROUND

Data privacy is a critical concern in federated learning (FL), where a server and multiple clients train a model collaboratively on distributed data that contain sensitive information. As a rigorous framework for protecting sensitive information, differential privacy (DP) has been widely adopted in FL to address the privacy concern. However, traditionally the current approach for DP in FL predominantly focuses on horizontally partitioned data, where the sensitive dataset is partitioned among clients by records (i.e., rows). Federated learning naturally preserves some level of data privacy, by keeping the client's data localized, and providing the server and other clients with restricted access to the local data. In the meantime, secure multiparty computation (MPC) has been applied to FL to further enhance data privacy, in the sense that clients can jointly compute a function using MPC, without exposing their sensitive inputs to others directly. However, MPC alone only prevents privacy leakage during the process of the computation, and does not prevent an adversary from inferring the private input from the sensitive outcome of the computation. In other words, MPC solves the problem of how to compute the sensitive outcome without revealing the private inputs, but what MPC computes (i.e., the outcome) still leaks information about the inputs.

Currently, the use of DP in FL for vertically partitioned data (vertical FL), where the dataset is partitioned by attributes (e.g., columns), has not been done. Accordingly, efficient and trusted approaches for DP in FL for vertically partitioned data is desired.

### SUMMARY

Various embodiments concern a computer system for implementing differentially private principal component analysis (PCA) for vertically partitioned data. The system includes a first client possessing a first column vector, and a second client possessing a second column vector. The first client is configured to discretize the first column vector to obtain a first discretized column vector and the second client is configured to discretize the second column vector to obtain a second discretized column vector. The first client is configured to introduce a first noise to the first discretized column vector and the second client is configured to introduce a second noise to the second discretized column vector to obtain a PCA result.

According to one embodiment, the PCA result is a combination of the first discretized column vector with the first noise and the second discretized column vector with the second noise.

According to one embodiment, first client and the second client are configured to send the PCA result to a server for further processing using a secret sharing protocol.

According to one embodiment, the secret sharing protocol is a Ben-Or, Goldwasser and Widgerson (BGW) protocol.

According to one embodiment, the BGW protocol is used to compute the first discretized column vector with the first noise and the second discretized column vector with the second noise into the PCA result without the first client knowing the second discretized column vector and without the second client knowing the first discretized column.

According to one embodiment, the server is configured to reduce the PCA result into a covariance matrix to reduce the size of data.

According to one embodiment, the first client is configured to introduce the first noise and the second client to configured to introduce the second noise using a predetermined noise parameter.

According to one embodiment, the first noise and the second noise are Skellam noises.

According to one embodiment, the first client is configured to discretize the first column vector and the second client is configured to discretize the second column vector using a predetermined discretization algorithm to reduce the size of the first column vector and the second column vector.

Various embodiments concern a computer implemented method for implementing differentially private principal component analysis (PCA) for vertically partitioned data including: discretizing a first column vector from a first client to obtain a first discretized column vector; discretizing a second column vector from a second client to obtain a second discretized column vector; introducing a first noise to the first discretized column vector using the first client and introducing a second noise to the second discretized column vector using the second client to obtain a PCA result.

According to one embodiment, the PCA result is a combination of the first discretized column vector with the first noise and the second discretized column vector with the second noise.

According to one embodiment, first client and the second client are configured to send the PCA result to a server for further processing using a secret sharing protocol.

According to one embodiment, the secret sharing protocol is a BGW protocol.

According to one embodiment, the BGW protocol is used to compute the first discretized column vector with the first noise and the second discretized column vector with the second noise into the PCA result without the first client knowing the second discretized column vector and without the second client knowing the first discretized column.

According to one embodiment, the server is configured to reduce the PCA result into a covariance matrix to reduce the size of data.

According to one embodiment, the first client is configured to introduce the first noise and the second client to configured to introduce the second noise using a predetermined noise parameter.

According to one embodiment, the first noise and the second noise are Skellam noises.

According to one embodiment, the first client is configured to discretize the first column vector and the second client is configured to discretize the second column vector using a predetermined discretization algorithm to reduce the size of the first column vector and the second column vector.

According to one embodiment, a computer program element is provided comprising program instructions, which, when executed by one or more processors, cause the one or more processors to perform the method described above.

According to one embodiment, a computer-readable medium is provided comprising program instructions, which, when executed by one or more processors, cause the one or more processors to perform the method described above.

It should be noted that embodiments described in context of the method for using a system for implementing differentially private principal component analysis (PCA) for vertically partitioned data are analogously valid for the system and vice versa.

### BRIEF DESCRIPTION OF THE DRAWINGS

The invention will be better understood with reference to the detailed description when considered in conjunction with the non-limiting examples and the accompanying drawings, in which:

FIG. 1 shows an exemplary system for implementing differentially private principal component analysis (PCA) for vertically partitioned data according to an embodiment.

FIG. 2 shows an exemplary method for implementing differentially private principal component analysis (PCA) for vertically partitioned data according to an embodiment.

FIG. 3 shows charts showing performance of PCA under various conditions according to an embodiment.

FIG. 4 shows charts showing performance results under various conditions according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the systems or methods are analogously valid for the other systems or methods. Similarly, embodiments described in the context of a system are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

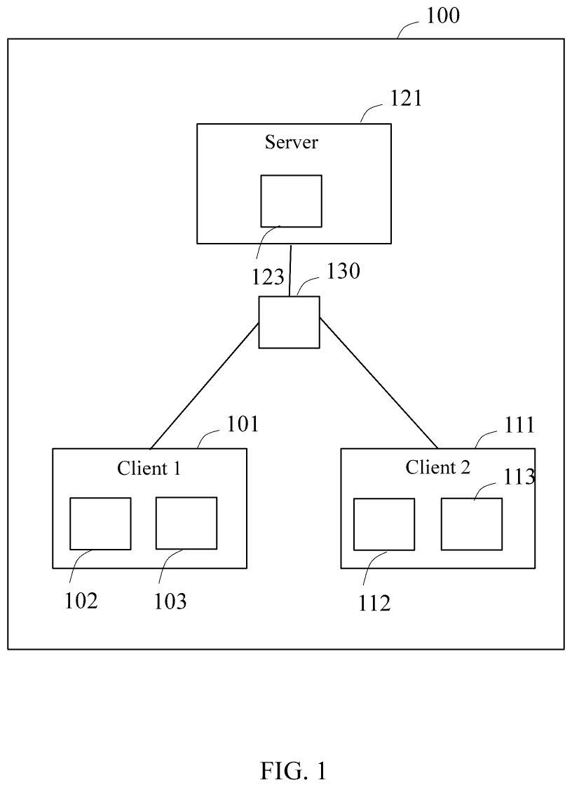

FIG. 1 shows an exemplary system for implementing differentially private principal component analysis (PCA) for vertically partitioned data according to an embodiment.

In various embodiments, data privacy is a central concern in federated learning (FL) where a server and multiple clients train a model collaboratively on distributed data. Federated learning naturally preserves some level of data privacy, by keeping the client's data localized, and providing the server and other clients with restricted access to the local data. In the meantime, secure multiparty computation (MPC) has been applied to FL to further enhance data privacy, in the sense that clients can jointly compute a function using MPC, without exposing their sensitive inputs to others directly. However, MPC alone only prevents privacy leakage during the process of the computation, and does not prevent an adversary from inferring the private input from the sensitive outcome of the computation.

In other words, MPC solves the problem of how to compute the sensitive outcome without revealing the private inputs, but what MPC computes (i.e., the outcome) still leaks information about the inputs.

In various embodiments, it is desirable to design a mechanism that (approximately) computes principal components of an input dataset, while preserving two levels of differential privacy simultaneously. These privacy guarantees encompass the individual records within the dataset as well as the local partition of each participating client in the FL process.

The system which may be referred to as SSS-PCA (Skellam Secret Sharing-PCA), neatly integrates Skellam noise, which enables DP in FL, and employs Secret Sharing, which further enhances privacy. More details of the system will be described below.

In various embodiments, the system 100 includes a first client 101, a second client 111 and a server 121.

In various embodiments, the first client 101 may possess a first column vector 102 containing data of the first client 101. The first client may include a first client processor 103 for performing any computer implemented functions regarding the first column vector 102.

In various embodiments, the second client 111 may possess a second column vector 112 containing data of the second client 111. The second client 111 may include a second client processor 113 for performing any computer implemented functions regarding the second column vector 112.

In various embodiments, the server 121 may include a server processor 123 for performing any computer implemented functions regarding the column information or data of the first client 101 and the second client 111.

In various embodiments, there is a processor 130 for processing information from the first client 101 and the second client 111. The processor 130 may be a part of server 121 or may be separated from server 121.

In various embodiments, the first client is configured to discretize the first column vector to obtain a first discretized column vector.

In various embodiments, the second client is configured to discretize the second column vector to obtain a second discretized column vector.

In various embodiments, the first client to configured to introduce a first noise to the first discretized column vector and the second client to configured to introduce a second noise to the second discretized column vector to obtain a PCA result.

In various embodiments, there is a processor 130 for processing information from the first client 101 and the second client 111.

In various embodiments, the processor 130 may receive the first discretized column vector and the first noise and/or the first discretized column vector with the first noise from the first client and the second discretized column vector and the second noise and/or the second discretized column vector with the second noise from the second client. The processor 130 may use the first discretized column vector and the first noise and/or the first discretized column vector with the first noise and the second discretized column vector and the second noise and/or the second discretized column vector with the second noise to obtain the PCA result.

In various embodiments, the PCA result is a combination of the first discretized column vector with the first noise and the second discretized column vector with the second noise.

In various embodiments, the first client and the second client are configured to send the PCA result to a server for further processing using a secret sharing protocol.

In various embodiments, the secret sharing protocol is a BGW protocol.

In various embodiments, the BGW protocol is used to compute the first discretized column vector with the first noise and the second discretized column vector with the second noise into the PCA result without the first client knowing the second discretized column vector and without the second client knowing the first discretized column.

In various embodiments, the server is configured to reduce the PCA result into a covariance matrix to reduce the size of data.

In various embodiments, the first client is configured to introduce the first noise and the second client to configured to introduce the second noise using a predetermined noise parameter.

In various embodiments, the first noise and the second noise are Skellam noises.

In various embodiments, PCA is a dimensionality reduction method that is used to reduce the dimensionality of large data sets, by transforming a large set of variables into a smaller one that still contains most of the information in the large set. Thus, PCA has the ability to reduce data size of information such as the first column vector 102 and the second column vector 112.

Advantageously, PCA aims at reducing the number of attributes of the dataset D while capturing its covariance by performing a linear transformation. Covariance measures the total variation of two random variables from their expected values. Using covariance, we can only gauge the direction of the relationship (whether the variables tend to move in tandem or show an inverse relationship).

In various embodiments, for a dataset (matrix) D∈ [symbol] ^{m×n}, represents the number of records and n represents the number of attributes in D. In various embodiments, a rank-k subspace (e.g., a matrix A∈ [symbol] ^{n×k}), with the goal of maximizing the variance in DA, which is equivalent to finding the top k eigenvectors of the covariance matrix C=D^{T}D

The covariance matrix C is computed as:

$$C [ i , j ] = {\sum }_{l = 1}^{m} ( D [ l , i ] \cdot D [ l , j ] ) , \qquad ( 1 )$$

for i, j∈[n]. Given the optimal rank-k subspace, Vₖ (e.g., the k-dimensional principal singular subspace of C), the error of a rank-k subspace A on describing matrix D is defined as:

$$err = {‖ {DV}_{k} ‖}_{F}^{2} - {‖ DA ‖}_{F}^{2} . \qquad ( 2 )$$

where ∥·∥F denotes the Frobenius norm of a matrix. The error reaches the minimum (0) when the columns of A match the principal rank-k right singular subspace of D.

In various embodiments, differential privacy is a mathematical framework for ensuring the privacy of individuals in datasets. It can provide a strong guarantee of privacy by allowing data to be analyzed without revealing sensitive information about any client in the dataset.

In various embodiments, differential privacy (DP) quantifies the indistinguishability of the output distributions for a mechanism on neighbouring datasets, where D and D′ are called neighbouring datasets if they differ by one record (written as D˜D′).

In various embodiments, there may be three types of DP (different definitions).

In various embodiments, for definition 1 ((ϵ, δ)—A randomized mechanism M: D→Y satisfies (ϵ, δ) differential privacy (DP) if for any [symbol] it holds that:

$${sup}_{D \sim {D}^{′}} Pr [ ℳ ( D ) ∈ 𝒪 ] \leq exp ( ϵ ) \cdot Pr [ ℳ ( {D}^{′} ) ∈ 𝒪 ] + δ . \qquad ( 3 )$$

Here smaller ϵ or δ imply higher difficulty in distinguishing the distributions, and hence stronger privacy guarantees. Given a mechanism (function) of interest, a canonical approach to make it differentially private is to perturb its outcome by injecting random noise, the scale of which is calibrated to the sensitivity of the mechanism.

In various embodiments, for definition 2, let ∥·∥ represent a norm measure of interest (e.g. L2-norm), then the sensitivity S(M) of a function M: D→Rn, denoted as S(M), is defined as

$$S ( ℳ ) = {max}_{D \sim {D}^{′}} ‖ ℳ ( D ) - ℳ ( {D}^{′} ) ‖ .$$

In various embodiments, for definition 3, a randomized mechanism M satisfies (α, τ) Renyi differential privacy (RDP) for some a α∈(0, 1)∪(1, ∞) if

$${sup}_{D \sim {D}^{′}} {D}_{α} ( ℳ ( D ) ‖ ℳ ( {D}^{′} ) ) \leq τ .$$

where Dα(P∥Q) denotes the Renyi divergence of P from Q that are defined over the same domain.

In various embodiments, secret sharing is a class of methods for distributing a secret among a group of parties in a way such that: 1) no single party is able to learn any non-trivial information about the secret; 2) when a sufficiently large number of parties combine their information, the secret is reconstructed.

Lagrange interpolation theorem, states that N points on a polynomial uniquely define a polynomial of degrees lower than N. With this in mind, the secret holder divides the secret into N shares by computing N points on a polynomial of degree N−1, whose constant term is exactly the original secret, and the other N−1 coefficients are randomly selected by the secret holder and kept privately. As a result, any subset of less than N parties cannot learn anything non-trivial about the secret. On the other hand, N parties can reconstruct the secret by polynomial interpolation.

In various embodiments, a type of secret sharing may be a BGW (Ben-Or, Goldwasser and Widgerson) protocol.

In various embodiments, in BGW protocol, the outcome of a polynomial function f(s1, . . . , sN), where the function is known to all parties, without revealing the private input to others. The three-step execution of BGW is as follow:
1. First, each client distributes their private input as a secret share to other clients, using the Shamir's algorithm. Note that no client can infer any other client's private input, which is enforced by the security property of Shamir's algorithm.
2. Next, each client simulates the computation of function f using a digital circuit while keeping the value of each secret as secret shared by all parties. Similar to the first step, the value of each secret cannot be inferred by any party.
3. Finally, all of the clients reconstruct the true outcome of f, using their secret shares.

The BGW protocol achieves a notion of information-theoretic security, e.g., every client can learn absolutely no more information about other clients' private inputs than what can be learned from the output itself, i.e. f (s1, . . . , sN). Note that this guarantee of BGW is different from DP since an adversary can still extract information of the private inputs from the sensitive outcome of f.

In various embodiments, noise is introduced to the first vertical column and the second vertical column for additional privacy. The noise can be a Gaussian noise or a Skellam noise. Skellam noise is noise which uses skellam distribution.

A random variable Z obeys a symmetric Skellam distribution with respect to a parameter μ if it is the difference between two independent Poisson random variables of the same parameter μ. By linearity of Poisson distributions, the sum of two independent Skellam noise sampled from Sk(μ1) and Sk(μ2) has distribution Sk (μ1+μ2). Sk(μ) as the ensemble of n independent random variables sampled from Sk(μ). The following divergence guarantee for perturbing the outcome of an integer-valued function with noises sampled from Skn(μ).

For any integer α>1, and any n-dimensional integer-valued function F with bounded output range, it holds that:

$${D}_{α} ( F ( D ) + {Sk}^{n} ( μ ) ‖ F ( {D}^{′} ) + {Sk}^{n} ( μ ) ) \leq τ . \qquad ( 4 )$$

$$for {Δ}_{2} = {‖ F ( D ) - F ( {D}^{′} ) ‖}_{2} , {Δ}_{1} = {‖ F ( D ) - F ( {D}^{′} ) ‖}_{1} , and τ computed as$$

$$τ = \frac{{αΔ}_{2}^{2}}{4 μ} + {min}_{α > 1} ( \frac{( 2 α - 1 ) {Δ}_{2}^{2} + 6 {Δ}_{1}}{16 {μ}^{2}} , \frac{3 {Δ}_{1}}{4 μ} ) .$$

In various embodiments, for principal component analysis in vertical federated learning, let D∈ [symbol] ^{m×n} represent the sensitive data where each row D[i, :]∈ [symbol] ^{1×n} represents the i-th (i∈[m]) record vector consisting of n real-valued attributes, and each column D[:, j]∈ [symbol] ^{m×n} represents the vector of attribute j∈[n] from all records.

For vertical federated learning (VFL), where each of the clients possesses a collection of attributes (e.g., a subset of columns in D). More specifically, if there are N

clients, where client q possesses a portion Dq of D (q∈[N]). Here Dq consists of a collection of attributes Aq such that Dq={D [: , j]: j∈Aq}. Besides, it is assumed that the collections of columns (resp. attributes) {Dq: q=1, . . . , N} (resp. {Aq: q=1, . . . , N}) are mutually exclusive. Σ_{q=1}^{N}| [symbol] |=n. Given an integer k (usually k<<n), an untrusted server aims to (approximately) learn a rank k subspace \tilde{V}ₖ⁻∈ [symbol] ^{n×k} that preserves most of the variance in the original dataset D, namely, maximizing. [symbol] . The privacy-preserving mechanism disclosed is able to find such [symbol] , while preserving differential privacy regarding any individual record such as D[i, :] and any dataset portion of a client such as Dq.

In various embodiments, there are three entities involved in the threat model under vertical federated learning: an individual record D [i,: ] (i∈[m]), a client q possessing the dataset portion Dq (q∈[N]), and the untrusted server who wants to learn about dataset D.

First, it is assumed that every individual trusts every client, but not the server. This means that client q has full access to the corresponding private portion Dq containing the sensitive information of the individual records (including the information for identifying an individual) which is required to be protected against the server. The validity of such an assumption can be interpreted by an example. For example, a scenario of online shopping, given the same group of customers, each online retailer which is considered as a client, possesses the purchasing or browsing histories of each individual customer, which are considered as attributes. However, other than these trusted clients, an individual may not want any other entity, including the server, to know their own private record (including the information for identifying an individual), which also means that is considered private for the server. The above discussion leads to the following DP definition.

In Definition 4, ((ϵ, δ)-record-server DP). a randomized mechanism M satisfies (ϵ, δ) record server DP if for any set of output [symbol] ⊆Range( [symbol] ₛₑᵣᵥₑᵣ), it holds that:

$${sup}_{D \sim {D}^{′}} Pr [ {ℳ}_{server} ( D ) ∈ 𝒪 ] \leq exp ( ϵ ) \cdot Pr [ {ℳ}_{server} ( {D}^{′} ) ∈ 𝒪 ] + δ ,$$

Here “˜” represents the neighboring relation of two datasets (resp. matrices) that one can be obtained from the other by adding/removing one record (resp. row).

Using the online retailer example, a client (e.g., online retailer), also has the incentive to prevent their competitors to learn about their private data partition (e.g., customers' purchasing or browsing histories), since otherwise, a competitor may send personalized advertisements to the client's customers, which could cause damage to the client's business, leading to the following DP definition.

In Definition 5, a randomized mechanism M satisfies (ϵ, δ)-partition 210

client DP if for every client q and the private partition Dq and any set of output [symbol] ⊆Range ( [symbol] _{client q}); it holds that

$${sup}_{{D}_{q}^{c} \sim {D}_{q}^{′ c}} Pr [ {ℳ}_{client q} ( {D}_{q}^{c} ∘ {D}_{q} ) ∈ 𝒪 ] \leq exp ( ϵ ) \cdot Pr [ {ℳ}_{client q} ( {D}_{q}^{′ c} ∘ {D}_{q} ) ∈ 𝒪 ] + δ ,$$

Here “˜” represents the neighboring relation that one set can be obtained from the other by replacing one row. For any q=1, . . . , N, we use [symbol] to represent the complement matrix that takes Dq out of the complete matrix D. We write D_{q}^{c}◯D_{q} to represent the reverse operation, that is, constructing a matrix by concatenating Dq and [symbol] following the same order of indices as of D.

Note that the neighboring relation in partition-client DP is defined on the action of replacing one row, instead of the action of adding/removing one row in record-server DP. This is because every client already has full access to their private data portion, including the information needed to identify an individual. Hence, it is assumed that the records are aligned in the clients' partitions and that m is considered non-private for the clients, meaning that the only information that a client is curious about is the value of the attributes in other clients' partitions. Every party (either a server or a client) strictly follows the execution of M while trying to infer the private data in other clients' partitions.

In various embodiments, each client first independently perturb their local data (e.g., a submatrix) with random Gaussian noise. Next, all the clients reveal their perturbed local data to one of the clients (without loss of generality, say client 1), who then reconstructs the whole perturbed matrix; computes the covariance matrix; and sends top k eigenvectors of the covariance matrix to the server. The privacy guarantee of this baseline follows from the DP guarantee of additive Gaussian noise and that post-processing (computing the eigenvectors) preserves DP.

In various embodiments, the SSS-PCA, is built upon the classic DP algorithm for PCA and injects independent noises to the upper diagonal of the covariance matrix C=DTD defined as follows:

$$C [ i , j ] = {\sum }_{l = 1}^{m} ( D [ l , i ] \cdot D [ l , j ] ) ,$$

for i, j∈[n]. After this, an adversary could compute a k-dimensional singular subspace of the perturbed covariance matrix C^{˜} using standard non-DP algorithms. The privacy guarantee follows from the fact that C^{˜} is already differentially private and post-processing preserves DP.

First, the exact C[i, j] is computed from two columns D[: , i] and D[: , j], which could be stored in different clients. In such cases, the computation for C[i, j] cannot be done by one client alone, which requires use of secret sharing to perform this computation without directly revealing the private inputs (e.g., columns of D). However, secret sharing, does not prevent a curious party from inferring the private inputs from the computation outcome, thus injection of noise to the inputs preserve differential privacy.

The SSS-PCA is shown in Algorithm 1 below.

It is needed to compute the entry of the covariance matrix at the j-th column of the i-th row while preserving privacy. The first case is when both columns D[: , i] and D[: , j] (including the case when i=j). In such cases, client p who possesses the column(s) discretizes the column vector(s) using Algorithm 2, and obtains D[: , i] (and D[: , j]) (Line 5 in Algorithm 1), where the overline represents the discretized version. Next, the client samples a Skellam noise zp from Sk(2μ) (Line 6) and computes:

$$R [ i , j ] = {\sum }_{l = 1}^{m} \overline{D} [ l , i ] \cdot \overline{D} [ l , j ] + {z}_{p} , \qquad ( 5 )$$

| | Algorithm 1: SSS-PCA | | | |
|---|---|---|---|---|
| | Input: Private matrix D ∈ [symbol] ^{m×n}; number of clients N, discretization parameter γ, noise parameter μ. | | | |
| 1 | The server initializex \ddot{C} ∈ [symbol] ^{n×n} as a zero matrix. | | | |
| 2 | for i = 1 . . . n do | | | |
| 3 | \| | for j = i . . . n do | | |
| 4 | \| | \| | if Columns D[:, i] and D[:, j] are possessed by the same client p then | |
| 5 | \| | \| | \| | Client p discretizes the column vector(s) with parameter γ using Algorithm [symbol] and obtains |
| | \| | \| | \| | D̅[:, i] (and D̅[:, j]). |
| 6 | \| | \| | \| | Client p samples Skellam noise zₚ from Sk(2μ). |
| 7 | \| | \| | └ | Client p computes and reports the result of R[i, j] (defined as in Eq. [symbol] to the server. |
| 8 | \| | \| | else | |
| 9 | \| | \| | \| | Client p (resp. client q) who possesses column D[:, i] (resp. column D[:, j]) discretizes the |
| | \| | \| | \| | column vector with parameter γ using Algorithm [symbol] and obtains D[:, i] (resp. D̅[:, j]). |
| 10 | \| | \| | \| | Client p (resp. client q) samples Skellam noise zₚ (resp. z_{q}) from Sk(μ). |
| 11 | \| | \| | \| | Clients p and q use the BGW protocol to compute and report the results of R[i, j] (defined as |
| | \| | \| | └ | in Eq. [symbol] to the server. |

| | | | |
|---|---|---|---|
| 12 | └ | └ | $The server assigns \tilde{O} [ i , j ] = \tilde{O} [ j , i ] = \frac{1}{{γ}^{2}} \cdot R [ i , j ] .$ |

Output: \tilde{V}ₖ, the k-dimensional principal singular subspace (i.e., top k eigenvectors) of \tilde{C}.

Algorithm 2: Discretization Procedure

| | Input: Vector to discretize x ∈ [symbol] ⁿ, discretization parameter γ | |
|---|---|---|
| 1 | Initialize v ∈ [symbol] ⁿ as a zero vector. | |
| 2 | u ← γ − x, | |
| 3 | for each dimension j = 1 . . . n do | |
| 4 | \| | Flip a coin with heads probability u(j) − └u(j)┘. |
| 5 | \| | if Heads then |
| 6 | \| | \|_ v(j) ← └u(j)┘ + 1. |
| 7 | \| | else |
| 8 | \|_{—} | \|_ v(j) ← └u(j)┘. |

Output: Integer-valued vector u ∈ [symbol] ⁿ.

The client reports the outcome to the server (Line 7). The other case is when columns D[: , i] and D[: , j] are possessed by different clients, say client p and client q. In such cases, client p (resp. client q) who possesses the column vector D[: , i] (resp. vector D[: , j]) privately and independently discretizes the vector, obtaining the integer-valued column vector D[: , i] (resp. vector D[: , j]) (Line 9). Next, the two clients privately and independently generate two Skellam noises zp and zq from Sk(μ) (Line 10). After that, the two clients use the BGW protocol to compute:

$$R [ i , j ] = {\sum }_{l = 1}^{m} \overline{D} [ l , i ] \cdot \overline{D} [ l , j ] + {z}_{p} + {z}_{q} , \qquad ( 6 )$$

The two clients reports the outcome to the server (Line 11). After the computation is done for all upper diagonal entries, the server obtains the perturbed covariance matrix C^{˜} by downscaling the outcome (Line 12), and computes its top k eigenvectors on his own.

In various embodiments, the noise injection for R[i, j] in Eq. (6) has to be contributed by two clients (both zp and zq). Otherwise, the single client (or any other party) who perform the noise injection can infer private information about the underlying D from the exact outcome.

SSS-PCA satisfies DP, regarding both a record and a client.

Lemma 2. Given discretization parameter γ and noise parameter μ, Algorithm 1 satisfies (α, τserver) record-server RDP with:

$${τ}_{server} = \frac{{αΔ}_{2}^{2}}{8 μ} + min ( \frac{( 2 α - 1 ) {Δ}_{2}^{2} + 6 {Δ}_{1}}{64 {μ}^{2}} , \frac{3 {Δ}_{1}}{8 μ} ) , \qquad ( 7 )$$

Algorithm 1 also satisfies (α, τclient)-partition-client RDP with

$${τ}_{client} = \frac{{αΔ}_{2}^{2}}{μ} + min ( \frac{( 2 α - 1 ) {Δ}_{2}^{2} + 3 {Δ}_{1}}{4 {μ}^{2}} , \frac{3 {Δ}_{1}}{2 μ} ) , \qquad ( 8 )$$

$$where {Δ}_{2} = \sqrt{{γ}^{2} + d} and {Δ}_{1} = min ( {γ}^{2} + d , \sqrt{d} \sqrt{{γ}^{2} + d} ) .$$

Lemma 3. Let Vk be the rank-k subspace of the original matrix D and let V^{˜}k be the principal rank-k subspace of matrix C⁻ (computed with additive Skellam noise), then with high probability

$${‖ D {\tilde{V}}_{k} ‖}_{F}^{2} \geq {‖ {DV}_{k} ‖}_{F}^{2} - O ( k \sqrt{n} ) . \qquad ( 9 )$$

Lemma 3 quantifies how well V^{˜}k captures the variance of D. To prove Lemma 3, it suffices to quantify how well R captures the variance of γD. The problem is reduced to bounding the largest eigenvalue (spectral norm) of the matrix R−γ2DTD in the worst case, which can be decomposed as Ed+Ep, where Ed is a symmetric random matrix whose entries represent the randomness due to discretization (recall Line 4 in Algorithm 1) and Ep is a symmetric random matrix whose entries represent the randomness due to DP (e.g., each entry is sampled from Sk(2μ)). The entries (in the upper diagonal) of Ed are independent random variates that are uniformly bounded with finite variance and the entries (in the upper diagonal) of Ep are sub-exponential, which means that the largest eigenvalues of E_{d} and Eₚ are of order O (\sqrt{n}) with high probability 1−o (1/n).

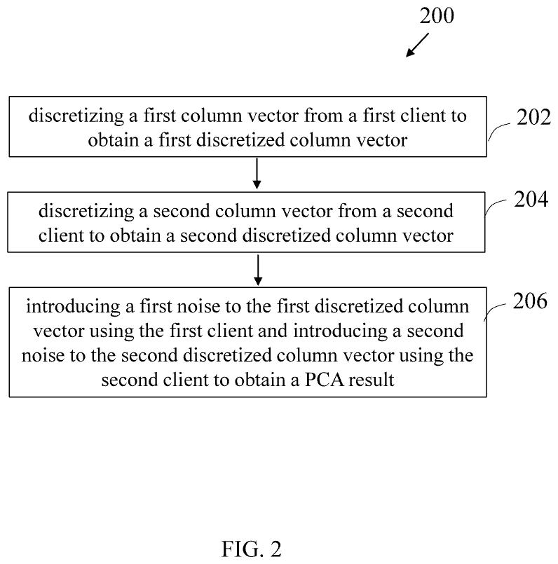

FIG. 2 shows an exemplary method for implementing differentially private principal component analysis (PCA) for vertically partitioned data according to an embodiment.

As shown in FIG. 2, there may be a method 200 for implementing differentially private principal component analysis (PCA) for vertically partitioned data. In the method 200, a first step 202 may include discretizing a first column vector from a first client to obtain a first discretized column vector. A second step 204 may include discretizing a second column vector from a second client to obtain a second discretized column vector. A third step 206 may include introducing a first noise to the first discretized column vector using the first client and introducing a second noise to the second discretized column vector using the second client to obtain a PCA result.

It will be understood that the above operations described above relating to FIG. 2 are not limited to this particular order. Any suitable, modified order of operations may be used.

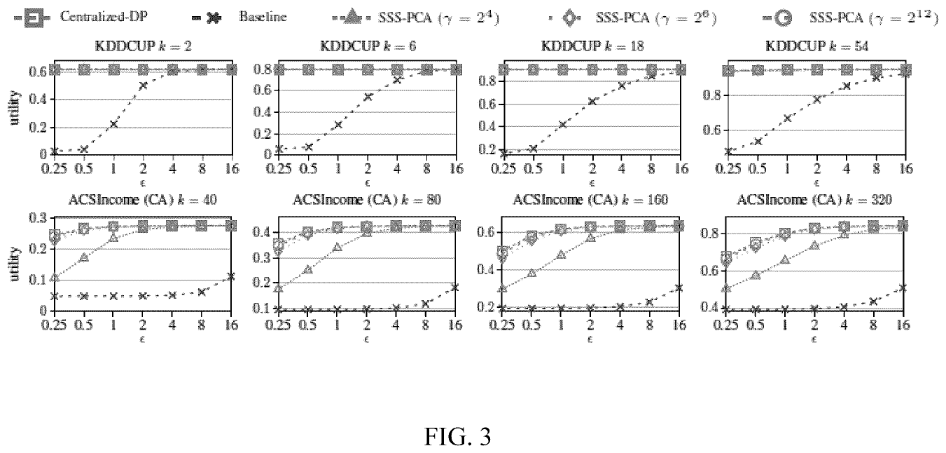

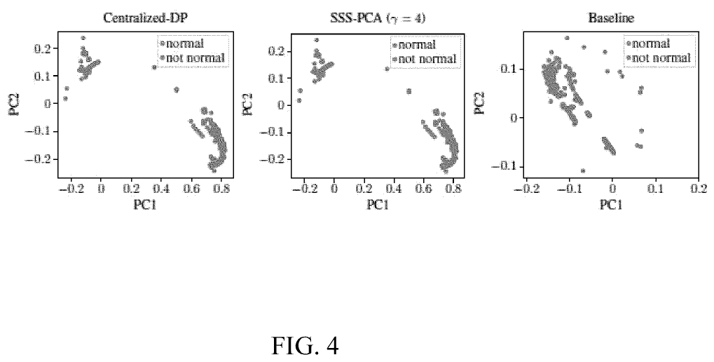

FIG. 3 shows charts showing performance of PCA under various conditions according to an embodiment. FIG. 4 shows charts showing performance results under various conditions according to an embodiment.

The solution is compared with existing solutions on KDDCUP dataset (m=195666 and n=817) and the ACSIncome dataset of California (m=145585 and n=117) and shown in FIGS. 3 and 4.

The average utility over 20 independent runs in FIG. 3, from which it is clear that the solution always outperforms the baseline solution and is close to the strong centralized-DP baseline under various parameter settings, confirming the efficacy of SSS-PCA. In particular, for KDDCUP, SSS-PCA performs almost the same as the strong centralized-DP baseline. For ACSIncome, the difference between SSS-PCA and the centralized baseline is only marginal when γ≥6, and note that even when γ=4, SSS-PCA still outperforms the distributed baseline by a large margin.

An illustration for k=2 on KDDCUP is shown in FIG. 4, where both the centralized-DP algorithm and the solution obtain high-quality 2-dimensional subspaces for the input dataset, as the normal and not normal points are separated with a large margin when projecting onto the subspaces.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g., a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

Claim language or other language reciting “at least one of”' a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, A and B, A and C, B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer system for implementing differentially private principal component analysis (PCA) for vertically partitioned data comprising:
a first client that has a first column vector; and
a second client that has a second column vector;
wherein the first client is configured to discretize the first column vector to obtain a first discretized column vector and the second client is configured to discretize the second column vector to obtain a second discretized column vector; and
wherein the first client is configured to introduce a first noise to the first discretized column vector and the second client is configured to introduce a second noise to the second discretized column vector to obtain a PCA result.

2. The computer system of claim 1, wherein the PCA result is generated based on a combination of the first discretized column vector with the first noise and the second discretized column vector with the second noise.

3. The computer system of claim 1, wherein at least one of the first client and the second client is configured to send the PCA result to a server for further processing using a secret sharing protocol.

4. The computer system of claim 3, wherein the secret sharing protocol is a Ben-Or, Goldwasser and Widgerson (BGW) protocol.

5. The computer system of claim 4, wherein the BGW protocol is used to compute the first discretized column vector with the first noise and the second discretized column vector with the second noise into the PCA result without the first client knowing the second discretized column vector and without the second client knowing the first discretized column vector.

6. The computer system of claim 3, wherein the server is configured to reduce the PCA result into a covariance matrix that has a reduced size relative to the PCA result.

7. The computer system of claim 1, wherein the first client is configured to introduce the first noise using a predetermined noise parameter and the second client is configured to introduce the second noise using the predetermined noise parameter.

8. The computer system of claim 1, wherein the first noise and the second noise are Skellam noises.

9. The computer system of claim 1, wherein the first client is configured to discretize the first column vector and the second client is configured to discretize the second column vector using a predetermined discretization algorithm to reduce a size of the first column vector and the second column vector.

10. A computer implemented method for implementing differentially private principal component analysis (PCA) for vertically partitioned data comprising:
discretizing a first column vector from a first client to obtain a first discretized column vector;
discretizing a second column vector from a second client to obtain a second discretized column vector; and
introducing a first noise to the first discretized column vector using the first client and introducing a second noise to the second discretized column vector using the second client to obtain a PCA result.

11. The computer implemented method of claim 10, wherein the PCA result is generated based on a combination of the first discretized column vector with the first noise and the second discretized column vector with the second noise.

12. The computer implemented method of claim 10, wherein at least one of the first client and the second client is configured to send the PCA result to a server for further processing using a secret sharing protocol.

13. The computer implemented method of claim 12, wherein the secret sharing protocol is a Ben-Or, Goldwasser and Widgerson (BGW) protocol.

14. The computer implemented method of claim 13, wherein the BGW protocol is used to compute the first discretized column vector with the first noise and the second discretized column vector with the second noise into the PCA result without the first client knowing the second discretized column vector and without the second client knowing the first discretized column vector.

15. The computer implemented method of claim 12, wherein the server is configured to reduce the PCA result into a covariance matrix that has a reduced size relative to the PCA result of data.

16. The computer implemented method of claim 10, wherein the first client is configured to introduce the first noise and the second client is configured to introduce the second noise using a predetermined noise parameter.

17. The computer implemented method of claim 10, wherein the first noise and the second noise are Skellam noises.

18. The computer implemented method of claim 10, wherein the first client is configured to discretize the first column vector and the second client is configured to discretize the second column vector using a predetermined discretization algorithm to reduce a size of the first column vector and the second column vector.

19. A non-transitory computer-readable medium comprising program instructions, which, when executed by one or more processors, cause the one or more processors to perform operations comprising:
obtaining a first discretized column vector;
obtaining a second discretized column vector; and
introducing a first noise to the first discretized column vector using a first client and introducing a second noise to the second discretized column vector using a second client to obtain a principal component analysis (PCA) result.

20. The non-transitory computer-readable medium of claim 19, wherein the PCA result is generated based on a combination of the first discretized column vector with the first noise and the second discretized column vector with the second noise.
